(19) United States
(12) Patent Application Publication
(10) Pub. No.: US 2024/0353574 A1
(43) Pub. Date: Oct. 24, 2024

(54) GNSS LOCALIZATION METHOD ASSISTED BY AN ARTIFICIAL INTELLIGENCE MODEL

(71) Applicant: Commissariat à l’Energie Atomique et aux Energies Alternatives, Paris (FR)

(72) Inventors: Ibrahim SBEITY, GRENOBLE (FR); Christophe VILLIEN, GRENOBLE (FR)

(21) Appl. No.: 18/641,346

(22) Filed: Apr. 20, 2024

(30) Foreign Application Priority Data
Apr. 21, 2023 (FR) 2304055

(51) Int. Cl. G01S 19/37

(52) U.S. Cl. CPC G01S 19/37

(57) ABSTRACT

A method is provided for training an artificial intelligence model to determine localization information for a satellite radionavigation receiver. A set of training data comprising multiple sets of satellite radionavigation measurements, each associated with reference positioning information, is received. For each set of measurements, a set of metrics comprising at least one set of residuals computed for multiple subsets of measurements, each excluding at least one measurement of the set, is determined. For each set of measurements, (i) a set of reference weighting coefficients, is determined; (ii) the artificial intelligence model is trained to produce a set of weighting coefficients based on sets of metrics for the training data, to minimize a distance between the weighting coefficients and reference weighting coefficients.

### CROSS-REFERENCE TO RELATED APPLICATION

This application claims priority to foreign French patent application No. FR 2304055, filed on Apr. 21, 2023, the disclosure of which is incorporated by reference in its entirety.

### FIELD OF THE INVENTION

The invention relates to the field of satellite positioning and navigation systems, known by the acronym GNSS (global navigation satellite systems).

The invention relates more specifically to a method for localizing a GNSS system, assisted by an artificial intelligence model.

### BACKGROUND

FIG. 1 shows a diagram of an architecture of a GNSS receiver according to the prior art. Such a receiver REC has the function of acquiring and processing satellite radionavigation signals or GNSS signals transmitted by satellites of one or more constellations among the existing GPS, Glonass, Galileo or else Beidou constellations. The signals are transmitted in one or more frequency bands, for example the L1, L2 or L5 bands.

The receiver REC comprises an antenna ANT and a radiofrequency input stage RF that amplifies, filters, frequency-transposes and digitizes the analogue signals received by the antenna ANT. It also comprises a baseband processing stage BB for acquiring the signals, demodulating them, extracting the data contained in the signals in order to generate GNSS messages MG and raw measurements MB relating to these signals. The receiver REC lastly comprises a navigation processor NAV configured to compute a positioning solution PVT that comprises positioning information in relation to the receiver and/or speed of movement information in relation to the receiver and/or time information, that is to say the clock of the receiver in relation to that of the satellite constellation.

More specifically, the baseband processing stage BB provides the navigation processor NAV with at least the following elements:
Raw measurements MB containing at least one of the following measurements: pseudorange measurements, Doppler or pseudorange rate measurements, GNSS signal carrier wave phase measurements and GNSS signal reception times. It may also provide link quality indicators, such as the signal-to-noise ratio (C/NO).
GNSS messages MG containing at least: ephemerides or parameters for estimating satellite positions and speeds; satellite clock error correction parameters; elements characterizing the state of the satellites and the state of their measurements; parameters of an ionospheric delay estimation model.

### SUMMARY

The invention relates to the implementation of the navigation processor NAV, and more precisely the algorithm for estimating the positioning information PVT.

The navigation processor NAV receives, at input, the raw measurements MB and the GNSS messages MG and typically produces, for each of the satellites for which a signal is received, information including: a pseudorange measurement, a carrier phase measurement, a Doppler shift measurement.

The pseudorange or phase measurements may be used to determine the position and clock offset of the receiver, whereas the Doppler shift measurement is used to determine the speed and clock drift of the receiver.

For example, if considering a measurement of a pseudorange ρᵢ between a receiver having coordinates x, y, z and a satellite SVi having coordinates xᵢ, yᵢ, zᵢ, this measurement complies with the following relationship:

$${ρ}_{i} = {d}_{i} ( x , y , z ) + δ + {ε}_{i} \qquad 2.1$$

Where dᵢ is the geometric distance between the receiver and the satellite SVi,

$${d}_{i} ( x , y , z ) = \sqrt{{( x - {x}_{i} )}^{2} + {( y - {y}_{i} )}^{2} + {( z - {z}_{i} )}^{2}} \qquad 2.2$$

δ is a distance offset resulting from a clock offset Δt between the receiver and the constellation (with all satellites belonging to one and the same GNSS constellation being perfectly synchronized, the offset is the same for all satellites of the constellation) converted into metres by multiplying it by the speed of light c

$$δ = Δ t \cdot c \qquad 2.3$$

εᵢ is a measurement error caused by multiple phenomena such as:
measurement noise of the receiver, of the order of a few cm to a few metres,
propagation delays in the ionosphere and troposphere, of the order of a few cm to a few metres,
satellite position errors,
effects related to signal propagation.

The operation of the GNSS system is such that observations from various satellites are collected simultaneously during a period of time called an “epoch” (epoch=simultaneous transmissions of satellite signals) at the end of which a set of measurements {ρᵢ} is collected.

The computing of the position solution (x, y, z, δ) depends on the operating mode of the receiver. Indeed, a distinction is drawn between a tracking mode and what is known as a “single-epoch” mode.

The tracking mode is an operating mode of the receiver for which a solution has already been computed in a previous epoch k−1. In this case, the solution at the time k is obtained by updating the solution k−1 using the measurements collected in the epoch k. This computation is generally performed using a Kalman filter or one of its many derivatives (EKF, UKF, etc.).

What is known as the “single-epoch” mode is an operating mode of the receiver for which no previous solution is available. This mode, which is a priori less efficient than tracking mode, is nevertheless of interest for certain applications such as:
initializing the tracking algorithm,
use in a context of fusion with other measurement techniques such as inertial measurement units, where the computed solutions are filtered again by another algorithm,
in some applications (for example IoT for Internet of Things) where computing is performed remotely (in a remote server) and for which various constraints (consumption, data rate) only allow a one-off transfer of measurements from the sensor nodes/tags to be localized.

The invention relates more particularly, but not exclusively, to what is known as the “single-epoch” mode in that it aims to compute a positioning solution for a given epoch at the time k without the benefit of an earlier solution.

In what is known as single-epoch mode, the computation of a position solution (X=[x, y, z, δ]) comprising four unknowns may therefore be determined from all measurements {ρᵢ} collected in the epoch k using equation 2.1. Since the number of measurements N (typically from 4 to 50) is generally greater than the number of unknowns, which is at least equal to 4, the solution therefore has to be computed in the sense of a criterion of minimizing errors affecting the measurements—also called residuals-such as least squares. More specifically, the number of unknowns is equal to 4 when all received signals are transmitted by satellites of the same constellation (for example the GPS constellation). If the signals are transmitted by satellites of at least two constellations (for example GPS and Galileo), then the number of unknowns is equal to 5. Generally speaking, the number of unknowns is equal to 3+m, where m is the number of satellite constellations envisaged.

Relationship 2.4 gives the least squares equation for determining position solution X by searching for the solution that minimizes a weighted sum of squared residuals.

$$( x , y , z , δ ) = arg {min}_{x , y , z , δ} {\sum }_{i = 1}^{N} {ω}_{i} {{Δ}_{i} ( X )}^{2} \qquad 2.4$$

The residuals Δᵢ(X) correspond to the difference between the predicted measurement according to model 2.1 for solution X, on the one hand, and the measurement ρᵢ that is carried out, on the other hand, where x, y, z and δ are the solutions of equation 2.4.

$${Δ}_{i} ( X ) = {ρ}_{i} - ( {d}_{i} ( x , y , z ) + δ ) \qquad 2.5$$

And ωᵢ defines the weighting coefficient associated with the measurement #i, that is to say the “significance” this will have in the computing of the solution.

The term ωᵢ defines the weighting coefficient or weight associated with each measurement ρᵢ. The higher this is, the higher the contribution of the associated measurement will be to the computed solution. A zero weight ωᵢ=0 means that a measurement has no influence on the computed solution, and is therefore equivalent to the absence of this measurement. If the weight is non-zero, its significance is evaluated relative to the weights of the other measurements; its value alone therefore does not make it possible to define its significance.

The same type of equation as equation 2.5 may be established using phase measurements rather than pseudorange measurements, the two quantities being identical in their model, to within a coefficient.

The same type of equation may also be established in order to compute a speed solution (vₓ, v_{y}, v_{z}, β), including speed components and β the clock drift of the receiver, based on Doppler measurements.

In the remainder of the document, the invention is described for the purpose of searching for a position solution based on pseudorange measurements, but it may thus be extended directly to searching for a position solution based on phase measurements or searching for a speed solution based on Doppler measurements by applying the same algorithm.

There are multiple weighting strategies for the least squares solution given by equation 2.4. One possible solution consists in computing the weight on the basis of the probable error σᵢ associated with each measurement using the model of equation 2.6, that is to say the reciprocal of the variance of the probable error on the measurement of index i.

$${ω}_{i} = \frac{1}{{σ}_{i}^{2}} \qquad 2.6$$

Indeed, this weighting strategy has theoretical foundations (Bayesian estimate) that make it possible to justify it in certain hypotheses. In this case, the probable error σᵢ is the standard deviation associated with the distribution of the error in the measurement ρᵢ that is to say the distribution of the random term εᵢ in equation 2.1. In addition to its theoretical justification, this approach makes it possible to relate the value σᵢ expressed in metres to measurable physical phenomena. The distribution of measurement errors may thus be established empirically through test campaigns, or based on other known elements (satellite positioning precision, propagation in the ionosphere, noise of the receiver, etc.). Typically, the values σᵢ are between 1 m and 20 m, but may vary depending on the strength of the received signal or the elevation of the satellite, for example.

Techniques linking various additional metrics (signal-to-noise ratio C/N0, satellite elevation, etc.) to the assumed precision of the measurement are called stochastic weighting.

For example, the error variance may be obtained by way of the empirical model given in document [1] and repeated in equation 2.7.

$${σ}_{i}^{2} = \frac{1}{{sin}^{2} {θ}_{i}} ( {σ}_{1}^{2} + \frac{{σ}_{2}^{2}}{{γ}_{i}} ) \qquad 2.7$$

In which θᵢ and γᵢ respectively represent the elevation angle and the strength of the signal received from the satellite SVi, and σ₁² and σ₂² are two empirical terms.

Other empirical models may be used as a replacement for the one given above.

Although these empirical formulas are widely used, they are still difficult to adjust, and finer modelling of the distribution of each of the received measurements would enable performance to be improved. However, this finer modelling may prove to be extremely complex in practice, as there are many phenomena involved (state of the atmospheric layers, type of receiver, satellite positioning precision, presence of obstacles in the environment of the receiver, etc.) that are difficult to predict.

Moreover, in order to guarantee optimality and therefore good precision of the computed solutions, it is important for all of the measurements taken into account to establish this solution to comply with the model used a priori, that is to say within an expected error range.

However, many phenomena may significantly worsen the quality of a measurement, such as:
malfunctioning of the satellite,
an attack—for example jamming or decoying—on the GNSS signals,
the presence of obstacles (for example buildings in urban environments) blocking the direct path of the wave, resulting in the receiver measuring only a reflected path that will have travelled a distance potentially much greater than that expected.

These biased measurements therefore have to be detected as such and excluded from the computing of the solution or else assigned a zero weight, which is equivalent. Reference is then made to fault detection.

There is therefore a need for a localization method that makes it possible to better take into account uncertainties related to theoretical models for computing weighting coefficients when solving the solution using least squares. There is also a need for a localization method that makes it possible to reliably eliminate biased measurements from the computing of the positioning solution.

Existing integrity-monitoring schemes, such as receiver autonomous integrity monitoring, known by the acronym RAIM, determine whether there is a fault in a satellite measurement by examining the consistency of a set of redundant measurements. One way to do this is to use the solution separation method. The solution separation method for RAIM receivers is based on computing the difference between a complete navigation solution that is provided using all N visible satellites and a set of navigation sub-solutions that are provided using N-i visible satellites. When computing the set of navigation sub-solutions, the RAIM algorithm assumes that only one satellite failure occurs at a time.

However, with the introduction of new constellations (for example Galileo, BeiDou) and the continued use of existing constellations (for example global positioning systems (GPS and GLONASS)), it is more likely that there may be multiple simultaneous satellite failures at any given time. In addition, failures of entire constellations will also have to be taken into account by future integrity-monitoring schemes.

In response to the possibility of multiple failures occurring at the same time, advanced receiver autonomous integrity monitoring or ARAIM has been developed. The ARAIM technique is based on the solution separation method, but has been modified to take into account the occurrence of multiple simultaneous failures and constellation failures. For each failure to be monitored, a navigation sub-solution that does not include the measurements associated with the failure is created. For example, if two single simultaneous failures are to be monitored, then a set of sub-solutions based on eliminating all possible combinations of two satellites has to be created.

However, the increase in the number of visible satellites and the higher probabilities of simultaneous failures (as expected with new constellations) may considerably increase the number of sub-solutions to be created. This has a significant impact on the computing requirements of the algorithm, resulting in more expensive chips for the implementation of the receivers.

Many fault detection and exclusion (FDE) techniques have been developed and may be classified into two main categories depending on whether the fault is analysed in the measurement space (residual-based RAIM, denoted RB here) as described in [3] or in the solution space (solution-separation RAIM, denoted SS here) as described in [2].

In the case of RB methods, a first solution X₀ is computed using all measurements, and then a statistical test is performed on all residuals Δᵢ(X₀) in order to determine whether a fault is present among the measurements. Indeed, if all of the measurements comply with the expected model (for example a Gaussian model, with a given standard deviation), then the sum of squared residuals is given by the following relationship 3.1

$${χ}^{2} = {\sum }_{i = 1}^{N} {{Δ}_{i}}^{2} ( {X}_{0} ) \qquad 3.1$$

The sum of residuals follows a chi-2 law, and this hypothesis may be tested by comparing the value obtained with a threshold T.

$${χ}^{2} < T \qquad 3.2$$

In the case of SS methods, a first solution X₀ is computed using all measurements, along with N solutions Xᵢ each based on N−1 measurements excluding the satellite SVᵢ. Next, each of the solutions is compared (in terms of norm) with the solution X₀,

$${τ}_{i} = \vert {X}_{0} - {X}_{i} \vert \qquad 3.3$$

If none of them deviates by more than a certain predetermined threshold T,

$${τ}_{i} < T , i = 1 ... N \qquad 3.4$$

then this means that no measurement is faulty.

In both cases, if the test is inconclusive, this means that there is at least one fault among the measurements.

In order to exclude the fault, it is possible to construct N subsets of N−1 measurements and restart the operation. If one of the tests is satisfied, then all of the measurements associated with the subset are considered valid and the computed solution may be retained. On the other hand, if none of the tests are satisfied, the operation is repeated by constructing subsets of N−2 measurements, which will then be tested individually, and so on.

It should be noted that, in each iteration corresponding to a number h of faults tested, the number Lₕ of subsets to be constructed for each number of faults hypothesis h is given by the relationship:

$${L}_{h} < {C}_{h}^{n} = \frac{n !}{( n - h ) ! h !} \qquad 3.5$$

This number may quickly become considerable when the number of faults tested becomes large.

For example, a standard multi-constellation receiver is typically able to obtain 40 measurements, and, in an urban environment, the number of faults may frequently be between 3 and 10, leading to numbers of subsets to be tested between 9880 and 847660528, which may quickly become prohibitive in terms of computing cost.

It should be noted that all of these approaches have the common characteristic of relying on a decision (via a statistical test), that of including or not including certain measurements, but do not modify the weights associated with each of them, except by forcing to 0, which is equivalent to an exclusion.

Other known approaches are based on modifying weightings, such as the method proposed in reference [5].

This approach is distinguished by the assignment of non-zero weighting coefficients to measurements that are however detected as being affected by a fault, here caused mainly by multipath. The idea is to preserve a balance between reducing the weight of faulty measurements in the computing of the solution, on the one hand, and worsening the geometric dilution of precision caused by excluding faulty measurements, on the other hand.

Geometric dilution of precision relates to a problem of measurement imprecision due to geometric factors. In other words, the relative positions of the receiver and of the satellites have a significant impact on the precision of the position.

For example, for identical measurement precision, satellites that are “more aligned” in the sky will lead to poorer positioning precision than satellites that are distributed uniformly in the sky.

This phenomenon, called geometric dilution of precision or simply dilution of precision, may be quantified precisely based on even approximate positions (>1 km) of the receiver and the satellites. It is often represented in the form of multiplicative terms in the three directions of space, which make it possible to translate the measurement error into a position error in these same directions. For example, a horizontal dilution of precision (HDOP) of 2 means that a measurement error of 1 m (assumed to be identical for all satellites) results in a horizontal positioning error of 2 m.

The method proposed in [5] consists in:
Detecting all faulty measurements,
Iteratively reducing the weight of the faulty measurements until a maximum number of iterations is reached, or the geometric dilution of precision, computed taking into account the new weighting, passes a certain threshold,
The non-faulty measurements use the conventional formulas from the prior art, such as that of equation 2.7 for example.

Another approach proposed in [8] is concerned with adjusting the formulas for weighting the measurements in the case of multipath with a notion of learning (in the form of a linear regression of values), but it does not consider joint information (that is to say information based on computations combining multiple signals, such as residuals for example) as inputs for computing the weightings.

Reference [9] describes the use of a convolutional neural network (CNN) to classify GNSS signals into three categories: line-of-sight (LOS), non-line-of-sight (NLOS) and multipath (MP). However, this algorithm uses the outputs from the ranging processor correlators directly as inputs, these outputs being internal data that are generally not accessible outside the receiver, and does not use joint inputs, that is to say inputs involving multiple signals coming from various satellites at the same time. In addition, the outputs associated with each signal/satellite are of a discrete nature.

In summary, there is therefore a need to improve the methods from the prior art, in particular in terms of taking more precise account of errors and uncertainties of various origins that impact satellite radionavigation measurements.

The invention aims to propose a new localization method that aims to improve precision in terms of positioning or speed by virtue of better weighting of measurements.

The invention utilizes an artificial intelligence model that is trained to learn to determine, based on joint measurements carried out on all signals received within an epoch, a set of weighting coefficients that enable more precise computing of localization information via a least squares solution.

One subject of the invention is a computer-implemented method for training an artificial intelligence model intended to be used to determine localization information in relation to a satellite radionavigation receiver, the method comprising the following steps:
Receiving a set of training data comprising multiple sets of satellite radionavigation measurements each associated with reference positioning information,
Determining, for each set of measurements, a set of metrics comprising at least one set of residuals computed for multiple subsets of measurements each excluding at least one measurement of the set,
For each set of measurements,
   i. Determining a set of reference weighting coefficients,
   ii. Training the artificial intelligence model to produce a set of weighting coefficients based on the sets of metrics for the training data, so as to minimize a distance between said weighting coefficients and the reference weighting coefficients,
the weighting coefficients being intended to weight a set of residuals, equal to a difference between a measurement and predicted positioning information, when computing a prediction of positioning information by minimizing the sum of squared residuals weighted by the weighting coefficients.

According to one particular aspect of the invention, each reference weighting coefficient is associated with a satellite and depends on a residual computed as the difference between a pseudorange associated with a radionavigation measurement transmitted by this satellite and a reference pseudorange computed based on the reference positioning information.

According to one particular aspect of the invention, the reference positioning information is provided by a positioning means taken from among: an inertial system or a high-precision GNSS system or a combination of the two systems.

According to one particular aspect of the invention, the artificial intelligence model is an artificial neural network, for example a recurrent neural network.

According to one particular aspect of the invention, the set of measurements of the training data furthermore comprises a set of quality indicators of the received signal for each measurement.

Another subject of the invention is a method for localizing a satellite radionavigation receiver, comprising the following steps:
Receiving a set of N satellite radionavigation measurements, N being an integer at least equal to 4,
Determining, based on the received measurements, a set of metrics comprising at least one set of residuals computed for multiple subsets of measurements each comprising at most N−1 measurements,
Carrying out an inference phase on the artificial intelligence model trained by way of the training method according to the invention, based on said set of metrics, in order to determine a set of weighting coefficients,
Determining localization information based on said satellite radionavigation measurements and the weighting coefficients by searching for the value of the localization information that minimizes the sum of squared residuals, associated with the N measurements, weighted by the weighting coefficients.

According to one particular aspect of the invention, the satellite radionavigation measurements are pseudorange measurements and the localization information is a position of a receiver.

According to one particular aspect of the invention, a residual is defined by the difference between a pseudorange measurement and a prediction of this measurement.

According to one particular aspect of the invention, the satellite radionavigation measurements are phase measurements or Doppler measurements and the localization information is a position or a speed of a receiver.

According to one particular aspect of the invention, the set of metrics furthermore comprises a set of quality indicators of the received signal for each measurement.

Another subject of the invention is a satellite radionavigation signal receiver comprising a GNSS signal reception stage, a baseband processing stage and a navigation processor configured to carry out the steps of the localization method according to the invention.

Another subject of the invention is a computer program comprising instructions for carrying out the method according to the invention when the program is executed by a processor.

Another subject of the invention is a processor-readable recording medium on which there is recorded a program comprising instructions for carrying out the method according to the invention when the program is executed by a processor.

### BRIEF DESCRIPTION OF THE DRAWINGS

Other features and advantages of the present invention will become more apparent on reading the following description in relation to the following appended drawings.

FIG. 1 shows a diagram of a satellite radionavigation receiver according to the prior art,

FIG. 2 shows a diagram of a satellite radionavigation receiver according to the invention,

FIG. 3 shows a flowchart detailing the main steps of a method for determining localization information in relation to a GNSS receiver according to one embodiment of the invention,

FIG. 4 shows a flowchart detailing the steps of a method for training an artificial intelligence model intended to be used to determine localization information, according to one embodiment of the invention,

FIG. 5 shows a flowchart detailing the steps of a method for predicting localization information based on the artificial intelligence model trained by the method of FIG. 4, according to one embodiment of the invention,

FIG. 6 shows a residual matrix intended to be fed to an artificial intelligence engine according to a first exemplary embodiment,

FIG. 7 shows a residual matrix intended to be fed to an artificial intelligence engine according to a second exemplary embodiment.

### DETAILED DESCRIPTION

The description of the invention is given hereinafter for the case of a position determination based on pseudorange measurements, but the invention is applicable in a similar manner in order to determine speed or time information based on pseudorange, phase or Doppler measurements.

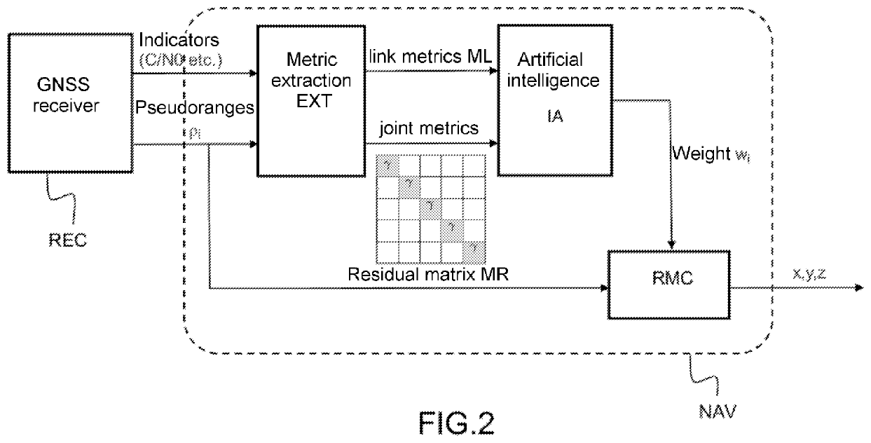

FIG. 2 schematically shows the functional architecture of a satellite radionavigation signal receiver according to one embodiment of the invention.

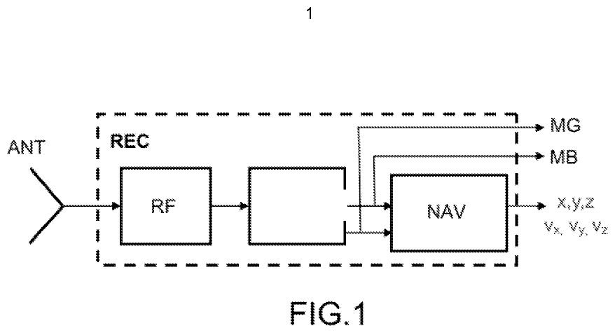

The receiver comprises a first reception stage REC that comprises an antenna, a radiofrequency stage RF and a baseband processing stage BB that are similar to those already described in FIG. 1.

The invention may be implemented in a digital navigation processor NAV, as shown in FIG. 2. As an alternative, the measurements provided by the reception stage REC may be transmitted to a remote server in which the invention is implemented.

The reception stage REC is able to receive various radionavigation signals transmitted by various satellites each transmitting on one or more frequencies and belonging to one and the same constellation or to different constellations. The signals are transmitted during an epoch.

The reception stage REC provides, at output, measurements of pseudoranges pi (or phase or Doppler measurements) along with various quality indicators of each received signal, for example a signal-to-noise ratio C/NO indicator or a lock time indicator.

A first metric extraction module EXT receives the measurements and indicators and provides, at output, a set of metrics characterizing the signals.

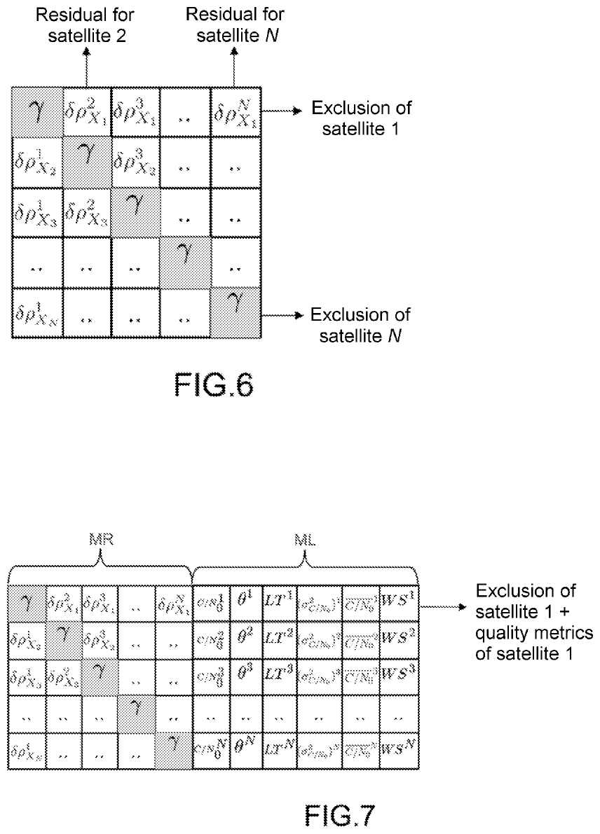

This set of metrics comprises at least one set of joint metrics, that is to say metrics computed based on multiple signals. The joint metrics are for example a set of residuals organized into a matrix MR as shown in FIG. 6, the residuals being computed based on each subset of N−1 satellites from among N satellites in visibility of the receiver and for which signals have been received.

Optionally, the set of metrics also comprises link metrics that correspond to or are computed based on the link indicators provided by the reception stage REC.

A second artificial intelligence module IA is configured to provide, at output, a set of weighting coefficients ωᵢ for each of the measurements. For example, the module IA is implemented by way of an artificial neural network trained using machine learning techniques.

A third least squares solution module RMC determines a positioning solution based on the pseudorange measurements provided by the reception stage REC and the weighting coefficients provided by the module IA by applying equation 2.4.

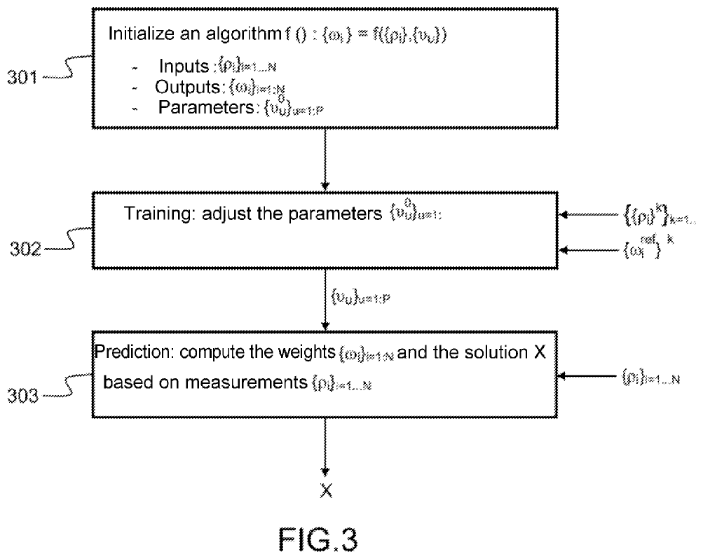

FIG. 3 schematically shows the main steps of the invention on a flowchart.

In step 301, the artificial intelligence model that is used is initialized; in particular, its parameters {vᵤ⁰}_{u=1:P} are initialized with a view to learning a function f that makes it possible to compute the weighting coefficients {ωᵢ}_{i=1:N} associated with measurements {ρᵢ}_{i=1 . . . . N}.

In step 302, the artificial intelligence model is trained so as to adjust its parameters in order to learn how to carry out the function f. The training is carried out on a number K of sets of measurements {{ρᵢ}^{k}}_{k=1 . . . . K}, for example associated with k known positions. The training is carried out such that the weighting coefficients that are obtained are as close as possible to reference coefficients {ωᵢ^{ref}}^{k}. The number K of sets of measurements used is such that K.N is greater than the number of parameters P (K.N>P) and is for example between 10000 and 10000000. N is the number of measurements carried out based on signals transmitted by different satellites.

Advantageously, the reference weighting coefficients are computed using equation 2.6 based on a known reference position solution X^{ref} that is for example provided by a high-precision receiver that may be equipped with an inertial measurement unit or any other means independent of GNSS signals.

The reference weighting coefficients correspond to residuals defined by equation 4.1

$${Δ}_{i}^{ref} ( {X}^{ref} ) = {ρ}_{i} - ( {d}_{i} ( {x}^{ref} , {y}^{ref} , {z}^{ref} ) + {δ}^{ref} ) \qquad 4.1$$

The reference weights are computed using an empirical model, for example the one given in equation 2.7.

The parameters {vᵤ⁰}_{u=1:P} are adjusted for example so as to minimize a cost function C that depends on a distance between the obtained weighting coefficients and the reference weighting coefficients.

The cost function C is for example given by relationship 4.2:

$$C ( \{ {v}_{u} \} ) = {\sum }_{k = 1}^{K} {\sum }_{i = 1}^{N} ‖ {\{ {ω}_{i}^{ref} \}}^{k} - {\{ {ω}_{i} \}}^{k} ‖ \qquad 4.2$$

In step 303, the artificial intelligence model trained in step 302 is then used to predict, based on new measurements, a set of weighting coefficients that are used to compute a positioning solution based on the least squares equation 2.4.

Each step of the invention will now be described in more detail.

The artificial intelligence model that is used may be an artificial neural network, for example a recurrent neural network or any other model that is able to be trained to learn how to execute a particular function.

According to one particular embodiment of the invention, the artificial intelligence model is a recurrent neural network or long short-term memory neural network (LSTM-NN). The network comprises for example two hidden layers of 893 and 517 neurons, respectively. The input layer comprises as many neurons as there are metrics provided by the metric extraction module EXT, and the output layer comprises a number N of neurons equal to the number of weighting coefficients to be generated, which is itself equal to the maximum number of measurements associated with different satellites that a receiver is able to receive. This parameter may be defined a priori.

The activation functions of the layers of the neural network are for example a tanh hyperbolic tangent function or a ReLU activation function. The parameters of the neural network, in particular the synaptic coefficients, are initialized to a predetermined value, for example 0 or 1 or a random value between 0 and 1.

The number of layers (1 to 100), the number of neurons (5 to 1000 per layer) and the number of parameters P=1000 to 100 000 000 may vary. The “activation function” of each layer may be chosen from examples such as ReLU, tanh or sigmoid, for example. The number of layers, just like the number of neurons and the choice of the activation function, may themselves form part of the parameters able to be optimized in the training step 302. Other types of network may also be used, such as fully connected networks or convolutional networks (CNN, convolutional NN), or else GRU (gate recurrent unit) networks, for example.

The input data of the neural network are normalized between 0 and 1 by dividing each of the values by a predetermined value (for example 10, 100 or 1000) or by the maximum value of the values computed on all of the input data.

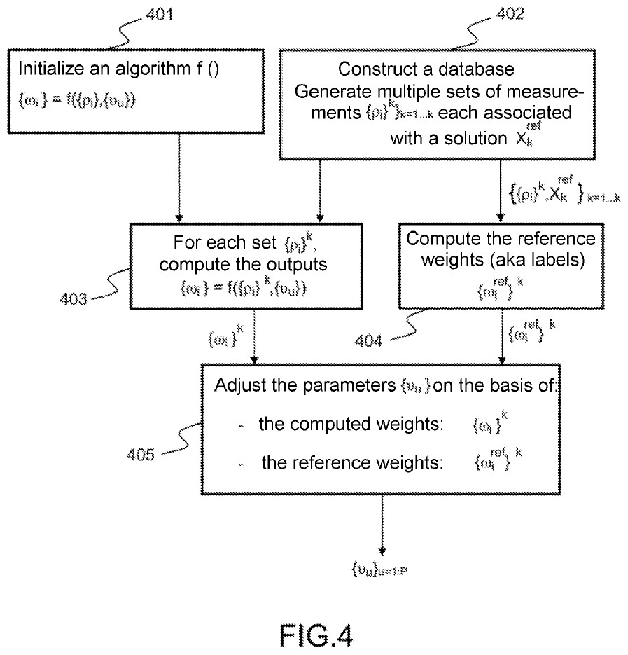

FIG. 4 shows, on a flowchart, the steps of implementing a method for training an artificial intelligence model according to one embodiment of the invention.

The method receives, at input, the parameters determined in the initialization phase represented by step 401 in FIG. 4.

Step 402 consists in generating a training database in order to train the model.

The training data consist of multiple test sets, each set consisting of multiple satellite radionavigation measurements and an associated reference positioning solution {{ρᵢ}^{k},Xₖ^{ref}}_{k=1 . . . K}.

The database may be constructed by collecting real measurements {ρᵢ}^{k} using a receiver and by measuring the reference position using a very-high-performance system (xₖ^{ref}, yₖ^{ref}, zₖ^{ref}), for example an inertial system or a high-precision GNSS system or a combination of the two systems. In this case, the clock offset of the receiver (not provided by the reference system, because it is specific to the receiver used for the collection) may be computed using relationship 5.1 (the index k is omitted for better legibility).

$${δ}^{ref} = \frac{1}{N} {\sum }_{i = 1}^{N} {ρ}_{i} - {d}_{i} ( {x}^{ref} , {y}^{ref} , {z}^{ref} ) \qquad 5.1$$

According to one variant embodiment, the training data comprise, in addition to pseudorange measurements, other metrics associated with each of the received signals, such as for example the signal-to-noise ratio C/NO or the lock time of the signal.

According to another variant embodiment, the training database is generated by simulation.

The training data are organized in the form of metrics identical to those produced by the metric extraction module, that is to say a residual matrix possibly supplemented by metrics specific to each link.

In step 403, for each set of measurements of the training database, an inference phase is carried out on the neural network in order to compute the weighting coefficients based on the parameters of the network.

In step 404, a set of reference weighting coefficients are determined. Advantageously, these are computed based on the reference position and the reference measurements using for example equation 2.6 or a similar equation.

For example, the reference weighting coefficients may be computed using one of the following formulas:

$${ω}_{i}^{ref} = \frac{1}{{( {Δ}_{i}^{ref} ( {X}^{ref} ) )}^{2}} = \frac{1}{{( {ρ}_{i} - ( {d}_{i} ( {x}^{ref} , {y}^{ref} , {z}^{ref} ) + {δ}^{ref} ) )}^{2}}$$

$${ω}_{i}^{ref} = \frac{1}{\vert {Δ}_{i}^{ref} ( {X}^{ref} ) \vert} ,$$

$${ω}_{i}^{ref} = {Δ}_{i}^{ref} ( {X}^{ref} ) ,$$

In step 405, the neural network is trained so as to adjust its parameters {vᵤ} on the basis of:
the computed weighting coefficients: {ωᵢ}^{k},
the reference weighting coefficients: {ωᵢ^{ref}}^{k}.

More specifically, the parameters are adjusted for example by way of:
a phase of propagating the training data in the neural network from the inputs of the network to its outputs in order to compute weighting coefficients {wᵢ}^{k},
computing an error between the computed output and the result to be obtained via a cost function,
an error backpropagation phase that aims to adjust the synaptic parameters or coefficients for each connection between two neurons using a backpropagation algorithm that aims to minimize the cost function. The backpropagation algorithm is based for example on a gradient descent or any other equivalent algorithm.

The cost function is a function of distance between the computed weighting coefficients and the reference weighting coefficients so as to make the computed weighting coefficients converge on the reference coefficients.

For example, the following cost function may be used as a replacement for the one given in equation 4.2:

$$C ( \{ {v}_{u} \} ) = {\sum }_{k = 1}^{K} {\sum }_{i = 1}^{N} ‖ {\{ \frac{1}{{ω}_{i}^{ref}} \}}^{k} - {\{ \frac{1}{{ω}_{i}} \}}^{k} ‖ \qquad 5.2$$

Any other cost function reflecting a deviation between the coefficients computed by the algorithm and the reference coefficients may be used.

Once the model has been trained, it may be used to predict positioning information.

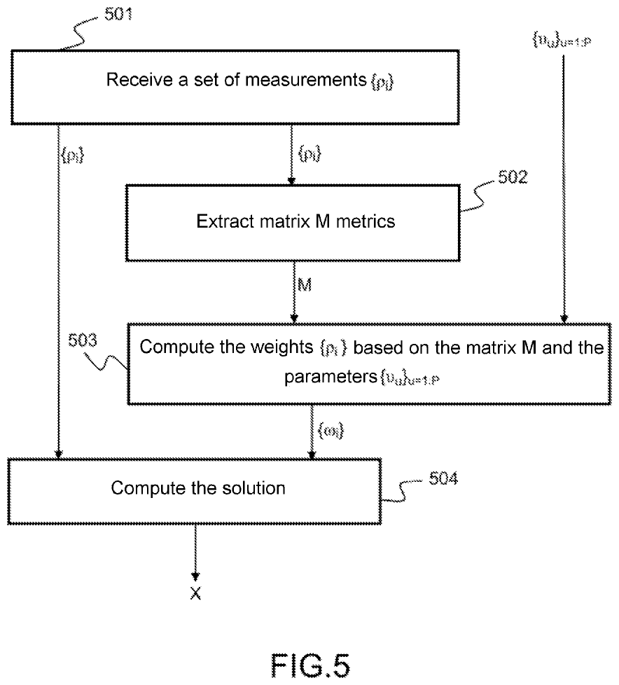

FIG. 5 schematically shows the steps for implementing a localization method according to one embodiment of the invention.

In step 501, a new set of measurements acquired by a radionavigation receiver is received, for example a set of pseudorange measurements {ρᵢ} corresponding to one and the same GNSS epoch. The number N of measurements that are carried out may typically vary from around 4 to 50 measurements.

The receiver is able to receive satellite signals from various constellations (GPS, Galileo Glonass, Beidou, Qzs, etc.).

The receiver is able to receive multiple signals at different frequencies (L1, L2, L5, E1, E2 bands, etc.) for one and the same satellite. A single satellite may thus lead to the reception of multiple signals, for example, but only if the receiver has this ability (multiband receiver).

The receiver is able to produce, for each received signal, multiple types of measurements including:
Pseudorange measurements, carrier phase measurements, Doppler measurements.
Signal-to-noise ratio C/NO measurements, receiver lock time measurements.

Carrier measurements or Doppler measurements may be used instead of pseudorange measurements. In this case, the residual matrix is computed on the phase measurements or on the Doppler measurements.

Carrier measurements or Doppler measurements may be used in addition to pseudorange measurements. In this case, multiple residual matrices may be computed and presented at input of the algorithm.

In one variant embodiment, a selection is carried out within the measurements. Some measurements may be excluded from processing operations from the outset because they are assumed to be unreliable. A preliminary validity test may be based for example on a minimum elevation θᵢ of the satellite i: θᵢ>θₘᵢₙ, with θₘᵢₙ chosen to be between 1 and 15 deg for example (that is to say the measurement is retained if the elevation of the satellite is greater than the minimum value θₘᵢₙ); or on signal level criteria: C/N0>C/N0ₘᵢₙ

In step 502, a set of metrics is extracted from the measurements.

In one embodiment, step 502 consists in constructing a residual matrix M as illustrated in FIG. 6.

Such a matrix has dimensions N by N, where N is the number of measurements associated with different satellites. Each row of the matrix corresponds to a subset of measurements in which one satellite has been excluded. There are therefore N subsets of N−1 measurements. For each subset, N−1 residuals are computed using equations 2.4 and 2.5 and using an empirical model to determine the weighting coefficients. On each row of the matrix M, there are therefore N−1 values of residuals δ_{Xi}^{j}, where j is the index of the satellite and Xi corresponds to the set of measurements of index i. The residuals δ_{Xi}^{j} are computed while drawing a limit at the N−1 measurements of the set Xi.

The diagonal term of the matrix may be replaced by an arbitrary value taken from the range [1 1000], for example, or may correspond to the computing of a residual for the excluded measurement.

In order for the matrix to keep a constant size of dimensions N×N (thereby facilitating implementation) if the number of measurements received is less than N, then all missing coefficients are assigned a predefined value γ.

Other indicators may be added to the matrix M, such as the quality indicators of each link (C/N0(i), LTⁱ), or the elevation of the satellite θᵢ.

It is also possible to add statistical indicators derived from the link quality indicators. For example, it is possible to add empirical statistics such as the mean value C̅/̅N̅₀̅(i) and the standard deviation σ_{C/N0}² computed over a sliding window of M samples preceding the current epoch, along with the number of samples used to compute these empirical statistics (WSⁱ):

$$\overline{C / {N}_{0}} ( i ) = \frac{1}{N} {\sum }_{k = i - M}^{i} C / N 0 ( k ) ,$$

$${σ}_{C / N 0}^{2} = \frac{1}{N} {\sum }_{k = i - M}^{i} {( C / N 0 ( k ) - \overline{C / {N}_{0}} ( i ) )}^{2}$$

If other information relating to each link is used in addition to the residuals, said other information may advantageously be added to the residual matrix as illustrated in FIG. 7 forming a feature matrix M composed of a residual matrix MR and a link metric matrix ML.

In all cases, the metrics determined in step 502 must be of the same nature as those used to train the neural network in the training phase.

The use of joint metrics, such as residuals computed for various subsets of measurements, makes it possible to provide the artificial intelligence model with more complete information than just the individual link quality metrics for each measurement. Based on all of these metrics, the artificial intelligence model is able to learn to identify which measurement is likely to be affected by an error, and then to assign it a lower-value weighting coefficient than the other measurements.

If the number of metrics obtained in step 502, which depends on the number of measurements carried out in step 501, is less than the number of metrics used in the training phase (corresponding to the number of inputs of the neural network), then the additional inputs of the neural network are supplemented by zero values or arbitrarily chosen values.

In step 503, the artificial intelligence engine trained in the training phase is executed in order to determine a set of weighting coefficients based on the metrics computed in step 502 that are provided thereto at input. The obtained weighting coefficients make it possible to weight measurements identified as reliable with higher values and measurements identified as erroneous with lower values. It is possible to characterize measurements as reliable or erroneous because the neural network has been trained to generate the best possible coefficients in a large number of different situations covered by the training data.

In particular, the training data advantageously cover a large number of application cases including scenarios for which certain measurements are affected by errors.

In one variant embodiment, the artificial intelligence engine may be trained to produce an output that is not directly a weighting coefficient as defined in equation 2.4, but linked thereto via a function g, such as for example:

$${σ}_{i} = g ( {ω}_{i} ) = \frac{1}{\sqrt{{ω}_{i}}} \qquad 5.4$$

In this case, in the training phase, the reference coefficients are transformed in the same way using the same function g.

In step 504, a positioning solution is computed based on the weighting coefficients determined in step 503 by the neural network.

The solution is computed based on equation 2.4 applied to the measurements {ρᵢ} and to the coefficients {ωᵢ} computed in step 503.

Various algorithms may be used to solve equation 2.4, such as recursive least squares, the Levenberg-Marquardt algorithm or gradient descent.

When the measurements originate from satellites belonging to multiple different constellations, it is necessary to estimate a clock offset per constellation. The definition of the solution therefore becomes X=[x, y, z, δ₁, . . . , δ_{N}] and the computing of the residual from equation 2.1 becomes equation 5.6:

$${Δ}_{i} ( X ) = {ρ}_{i} - ( {d}_{i} ( x , y , z ) + {δ}_{C} ) \qquad 5.6$$

Equation 5.6 uses the appropriate offset δ_{C}, where C denotes the constellation of the measurement under consideration.

The computing of the solution may be based on a previous solution (epoch k−1) that may be used to initialize the solution of equation 2.4 and thus speed up processing.

The solution may also be computed using filtering algorithms (of Kalman filter type) that update the solution obtained in the epoch k−1 (that is to say Xₖ₋₁) in order to compute the solution in the current epoch (that is to say Xₖ).

If step 503 does not produce weighting coefficients at output as defined in equation 2.4 (cf. variant of step 503 and equation 5.4), these will first be transformed by a function g( ) before being used.

The localization method described in FIG. 5 makes it possible to provide positioning information comprising at least one of the indications among a position, a speed or a clock time reference.

The localization method may be executed in a navigation processor NAV of a GNSS receiver of the type described in FIG. 2.

As an alternative, the localization method may be executed in a remote server based on measurements carried out by a GNSS receiver and then transmitted to this server.

Generally speaking, the training and localization methods according to the invention may be implemented using hardware and/or software components. The software elements may be available in the form of a computer program product on a computer-readable medium, which medium may be electronic, magnetic, optical or electromagnetic. Some or all of the hardware elements may be available notably in the form of dedicated integrated circuits (ASICs) and/or configurable integrated circuits (FPGAs) and/or in the form of neural circuits or in the form of a digital signal processor DSP and/or in the form of a graphics processor GPU, and/or in the form of a microcontroller and/or in the form of a general-purpose processor, for example.

### REFERENCES

[1] P. Groves “Principles of GNSS, Inertial and multisensor integrated navigation systems 2^{nd} edition” Artech House, 2013
[2] M. Joerger and B. Pervan “Fault detection and exclusion using solution separation and chi-squared ARAIM” IEEE TRANSACTIONS ON AEROSPACE AND ELECTRONIC SYSTEMS VOL. 52, NO. 2 Apr. 2016
[3] F. Haque, V. Dehghanian and A. O. Fapojuwo, “Fault Detection and Correction Using Observation Domain Optimization for GNSS Applications,” 2022 IEEE International Conference on Wireless for Space and Extreme Environments (WiSEE), Winnipeg, MB, Canada, 2022, pp. 61-66, doi:10.1109/WiSEE49342.2022.9926799.
[4] K. Zhang and P. Papadimitratos, “Fast Multiple Fault Detection and Exclusion (FM-FDE) Algorithm for Standalone GNSS Receivers,” in IEEE Open Journal of the Communications Society, vol. 2, pp. 217-234, 2021, doi: 10.1109/OJCOMS.2021.3050333.
[5] A. Pirsiavash, A. Broumandan, G. Lachapelle and K. O'Keefe, “Detection and De-weighting of Multipath-affected Measurements in a GPS/Galileo Combined Solution,” 2019 European Navigation Conference (ENC), Warsaw, Poland, 2019, pp. 1-11, doi: 10.1109/EURONAV.2019.8714191.
[6] Pirsiavash A, Broumandan A, Lachapelle G, O'Keefe K. GNSS Code Multipath Mitigation by Cascading Measurement Monitoring Techniques. Sensors (Basel). 2018 Jun. 19; 18(6): 1967. doi: 10.3390/s18061967. PMID: 29921798; PMCID: PMC6022099
[7] Groves, P., & Jiang, Z. (2013). Height Aiding, C/NO Weighting and Consistency Checking for GNSS NLOS and Multipath Mitigation in Urban Areas. The Journal of Navigation, 66(5), 653-669. doi: 10.1017/S0373463313000350
[8] Daniel Medina, Kasia Gibson*, Ralf Ziebold, Pau Closas, “Determination of Pseudorange Error Models and Multipath Characterization under Signal-Degraded Scenarios”
[9] WO2022/237989

1. Computer-implemented method for training an artificial intelligence model intended to be used to determine localization information in relation to a satellite radionavigation receiver, the method comprising the following steps:
receiving (402) a set of training data comprising multiple sets of satellite radionavigation measurements each associated with reference positioning information;
determining, for each set of measurements, a set of metrics comprising at least one set of residuals computed for multiple subsets of measurements each excluding at least one measurement of the set;
for each set of measurements,
i. determining (404) a set of reference weighting coefficients,
ii. training (403, 405) the artificial intelligence model to produce a set of weighting coefficients based on the sets of metrics for the training data, so as to minimize a distance between said weighting coefficients and the reference weighting coefficients;
the weighting coefficients being intended to weight a set of residuals, equal to a difference between a measurement and predicted positioning information, when computing a prediction of positioning information by minimizing the sum of squared residuals weighted by the weighting coefficients.

2. Method for training an artificial intelligence model according to claim 1, wherein each reference weighting coefficient is associated with a satellite and depends on a residual computed as the difference between a pseudorange associated with a radionavigation measurement transmitted by this satellite and a reference pseudorange computed based on the reference positioning information.

3. Method for training an artificial intelligence model according to claim 1, wherein the reference positioning information is provided by a positioning means taken from among: an inertial system or a high-precision GNSS system or a combination of the two systems.

4. Method for training an artificial intelligence model according to claim 1, wherein the artificial intelligence model is an artificial neural network, for example a recurrent neural network.

5. Method for training an artificial intelligence model according to claim 1, wherein each set of measurements of the training data furthermore comprises a set of quality indicators of the received signal for each measurement.

6. Method for localizing a satellite radionavigation receiver, comprising the following steps:
receiving (501) a set of N satellite radionavigation measurements, N being an integer at least equal to 4,
determining (502), based on the received measurements, a set of metrics comprising at least one set of residuals computed for multiple subsets of measurements each comprising at most N−1 measurements,
carrying out (503) an inference phase on the artificial intelligence model trained by way of the training method according to any one of the preceding claims, based on said set of metrics, in order to determine a set of weighting coefficients,
determining (504) localization information based on said satellite radionavigation measurements and the weighting coefficients by searching for the value of the localization information that minimizes the sum of squared residuals, associated with the N measurements, weighted by the weighting coefficients.

7. Method according to claim 6, wherein the satellite radionavigation measurements are pseudorange measurements and the localization information is a position of a receiver.

8. Method according to claim 7, wherein a residual is defined by the difference between a pseudorange measurement and a prediction of this measurement.

9. Method according to claim 6, wherein the satellite radionavigation measurements are phase measurements or Doppler measurements and the localization information is a position or a speed of a receiver.

10. Method according to claim 6, wherein the set of metrics furthermore comprises a set of quality indicators of the received signal for each measurement.

11. Satellite radionavigation signal receiver comprising a GNSS signal reception stage (RF), a baseband processing stage (BB) and a navigation processor (NAV) configured to carry out the steps of the localization method according to claim 6.

12. Computer program comprising instructions for carrying out the method according to claim 1 when the program is executed by a processor.

13. Processor-readable recording medium on which there is recorded a program comprising instructions for carrying out the method according to claim 1 when the program is executed by a processor.
